(19) United States
(12) Patent Application Publication
(10) Pub. No.: US 2026/0320458 A1
(43) Pub. Date: Oct. 15, 2026

(54) HYBRID QUANTUM-CLASSICAL CONTROL SYSTEM WITH A QUANTUM DECISION AGENT

(71) Applicant: Nirvanic Consciousness Technologies Inc., Vancouver (CA)

(72) Inventor: Suzanne Gildert, Vancouver (CA)

(21) Appl. No.: 19/466,247

(22) Filed: Jan. 30, 2026

Related U.S. Application Data
(60) Provisional application No. 63/752,179, filed on Jan. 31, 2025.

(51) Int. Cl. G06N 10/40; G06N 10/20

(52) U.S. Cl. CPC G06N 10/40; G06N 10/20

(57) ABSTRACT

A hybrid quantum-classical control system for an artificially intelligent entity, such as a physical robot, is described. The hybrid system employs a classical decision agent, a quantum decision agent, and an attention module that switches between the classical decision agent and the quantum decision agent as the source of action output instructions for the artificially intelligent entity. The attention module initiates control from the classical decision agent and switches to receive control information from the quantum decision agent in response to the classical decision agent being unable to retrieve a learned response for a given pattern of sensor data. Information from the quantum decision agent can be used to supply training data to the perception-action pattern library used by the classical decision agent.

### FIELD

The present disclosure pertains to quantum computing, artificial intelligence, and robotics, and a hybrid-quantum-classical control system for an artificially intelligent entity such as a physical robot.

### BACKGROUND

In recent years, artificial intelligence (AI) and robotics have gained substantial attention in both academic and industrial domains. Despite significant advances, current AI systems still rely on classical computation, which may limit their ability to emulate certain aspects of human decision-making. Classical AI models typically struggle with understanding and decision-making in situations outside of those seen in the training data, often known as edge-cases.

Classical AI often requires many thousands or millions of training examples of the problem being solved in order for the classical AI to learn a map from perception inputs to appropriate action outputs. Such systems often do not generalize to unfamiliar environments. This is especially important for AI-controlled machines in the physical world where the environment is evolving, dynamic, chaotic, or requires many social interactions, where it is impractical to collect the breadth of training data in advance required to anticipate a suitable response for any future encounter.

Quantum computing is presently being used to try to understand the behavior of physical systems. In an example, U.S. Pat. No. 11,605,015B2 to Anschuetz et al. describes a hybrid quantum-classical computing system for implementing and optimizing quantum Boltzmann machines to prepare and measure a thermal state on these systems. In another example, U.S. Pat. No. 11,599,823B2 to Liu et al. describes a quantum reinforcement learning agent that can facilitate applying a reinforcement learning policy to available actions.

This background information is provided for the purpose of making known information believed by the applicant to be of possible relevance to the present disclosure. No admission is necessarily intended, nor should be construed, that any of the preceding information constitutes prior art against the present disclosure.

### SUMMARY

An object of the present disclosure is to provide a hybrid quantum-classical control system for an artificially intelligent entity, such as a physical robot.

In an aspect there is provided a hybrid quantum-classical control system comprising: a quantum decision agent comprising an input qubit layer with a plurality of input qubits and an output qubit layer with a plurality of output qubits connected to the plurality of input qubits; a classical decision agent connected to a perception-action pattern library; an attention module connected to the quantum decision agent and the classical decision agent; a physical embodiment comprising a sensor for receiving data from the environment and sending the data to the attention module and an actuator for receiving a decision command from the quantum decision agent or the classical decision agent.

In an embodiment of the system, the quantum decision agent further comprises at least one hidden qubit layer comprising a plurality of hidden qubits connected to the plurality of input qubits and the plurality of output qubits.

In another embodiment of the system, information from the quantum decision agent is used to supply training data to the perception-action pattern library used by the classical decision agent.

In another embodiment of the system, the perception-action pattern library comprises sensorimotor patterns.

In another embodiment of the system, the attention module receives and processes information from the physical embodiment and selects which subset of information to route to either the quantum decision agent or the classical decision agent.

In another embodiment of the system, the physical embodiment comprises a plurality of sensors.

In another embodiment of the system, the sensor on the physical embodiment comprises one or more camera, microphone, temperature sensor, balance sensor, orientation sensor, LIDAR sensor, SONAR sensor, depth sensor, touch sensor, motor position sensor, torque sensor, strain sensor, current sensor, voltage sensor, proximity sensor, acceleration sensor, chemical detection sensor, pH monitor, button, switch, knob, magnetic sensor, optical sensor, optical mouse, haptic sensor, touch screen sensor, keyboard input, or mouse click detector.

In another embodiment of the system, the physical embodiment is a physical robot, virtual robot, avatar, game character, sensorimotor construct, autonomous mechanical construct, or agentic interface such as a desktop computer, laptop, cellphone or tablet.

In another embodiment of the system, the physical embodiment comprises a plurality of actuators.

In another embodiment of the system, the plurality of input qubits and the plurality of output qubits in the quantum decision agent have bias strengths and are connected by weights.

In another embodiment of the system, operation of the quantum decision agent is independent from operation of the classical decision agent.

In another embodiment of the system, the classical decision agent comprises a classical artificial intelligence (AI) that can be run in one or both of learning mode and inference mode.

In another embodiment of the system, the actuator on the physical embodiment comprises one or more motor or output device.

In another embodiment of the system, the motor or output device comprises a DC motor, servomotor, digitally controlled servomotor, piezo-electric actuator, muscle wire, nitinol-based actuator, heater, wheel, tank tread, light, LED display, OLED display, screen, buzzer, sound making device, or vibrational actuator.

In another embodiment of the system, the output device provides a control signal for activation of one or more software process internal to the physical agent, the software process comprising one or more of memory recall, attention switching, a classical decision agent subroutine, and modification of the quantum or classical decision agents'internal parameters, such as number of layers and number of qubits in the agent's neural network, and learning rate of the neural network.

In another aspect there is provided a method for controlling a physical embodiment comprising: receiving classical sensor data from a physical embodiment; in a classical decision agent, attempting to match the classical sensor data to a stored feature pattern to a suitable threshold; if no match is found, in a quantum decision agent: converting the classical sensor data into quantum input data in a plurality of input qubits; entangling the plurality of input qubits with a plurality of output qubits to obtain a quantum state; annealing the quantum state; and measuring the quantum state to provide a classical data output; and sending the classical output as an action control signal to an actuation system on the physical embodiment.

In an embodiment of the method, the plurality of input qubits and plurality of output qubits are further entangled with a plurality of hidden qubits.

In another embodiment, the method further comprises adjusting weights and biases of the plurality of input qubits and the plurality of output qubits in the quantum decision agent based on a measurement result of a previous measurement.

In another embodiment, attempting to match the classical sensor information to a stored feature pattern is done using a classical AI decision agent.

In another embodiment, the classical sensor data comprises information about an environment of the physical embodiment.

In another embodiment, the actuation system affects the environment of the physical embodiment.

In another aspect there is provided a system comprising: one or more computers and one or more storage devices storing instructions that are operable, when executed by the one or more computers, to cause the one or more computing systems to perform operations for controlling a physical embodiment, the operations comprising: receiving classical sensor data from a physical embodiment; in a classical decision agent, attempting to match the classical sensor data to a stored feature pattern to a suitable threshold; if no match is found, in a quantum decision agent: converting the classical sensor data into quantum input data in a plurality of input qubits; entangling the plurality of input qubits with a plurality of output qubits to obtain a quantum state; annealing the quantum state; and measuring the quantum state to provide a classical data output; and sending the classical output as an action control signal to an actuation system on the physical embodiment.

A hybrid quantum-classical control system may be summarized as including: a quantum decision agent comprising a plurality of qubits; a classical decision agent connected to a perception-action pattern library; an attention module connected to both the quantum decision agent and the classical decision agent; and a physical embodiment comprising: at least one sensor that sends sensor data to the attention module; and at least one actuator that receives a decision command from the quantum decision agent or the classical decision agent.

The quantum decision agent may supply training data to the perception-action pattern library for use by the classical decision agent. The perception-action pattern library may include sensorimotor patterns of the physical embodiment. The attention module may receive and process information from the physical embodiment and select whether to route information to the quantum decision agent or to the classical decision agent. The at least one sensor may include at least one sensor selected from a group consisting of: a camera, a microphone, a temperature sensor, a balance sensor, an orientation sensor, a LIDAR sensor, a SONAR sensor, a depth sensor, a touch sensor, a motor position sensor, a torque sensor, a strain sensor, a current sensor, a voltage sensor, a proximity sensor, an acceleration sensor, a chemical detection sensor, a pH monitor, a button, a switch, a knob, a magnetic sensor, an optical sensor, an optical mouse, a haptic sensor, a touch screen sensor, a keyboard input, and a mouse click detector.

The physical embodiment may be selected from a group consisting of: a physical robot, a virtual robot, an avatar, a game character, a sensorimotor construct, an autonomous mechanical construct, an agentic interface, a desktop computer, a laptop, a cellphone, and a tablet. The plurality of qubits may have bias strengths and may be connected by weights. Operation of the quantum decision agent may be independent from operation of the classical decision agent. The classical decision agent may include a classical artificial intelligence (AI) operable in either or both of learning mode and inference mode. The at least one actuator may include at least one motor selected from a group consisting of: a DC motor, a servomotor, a digitally controlled servomotor, a hydraulic actuator, a pneumatic actuator, and a piezo-electric actuator.

The at least one actuator may include at least one output device selected from a group consisting of: a muscle wire, a nitinol-based actuator, a heater, a wheel, a tank tread, a light, a LED display, an OLED display, a screen, buzzer, a sound making device, and a vibrational actuator. The output device may provide a control signal for activation of at least one software process of the physical embodiment, and the at least one software process may be selected from a group consisting of: a memory recall, an attention switching, a classical decision agent subroutine, a modification of an internal parameter of the quantum decision agent, and a learning rate of a neural network of the classical decision agent.

The system may further include: one or more classical processors and one or more storage devices storing the classical decision agent, wherein the classical decision agent comprises instructions that are operable, when executed by the one or more classical processors, to cause the one or more classical processors to perform operations of the classical decision agent. The one or more storage devices may further store the perception-action pattern library and the attention module.

A method for controlling a physical embodiment may be summarized as including: receiving classical sensor data from the physical embodiment; in a classical decision agent, attempting to match the classical sensor data to a stored feature pattern within a threshold; if a match within the threshold is found, in the classical decision agent: looking up a learned response for the stored featured pattern; and outputting the learned response to control an actuator of the physical embodiment; if no match within the threshold is found, in a quantum decision agent: converting the classical sensor data into quantum input data for a plurality of qubits; evolving a quantum state of at least some of the plurality of qubits; measuring the quantum state; converting the quantum state into an action control signal; and outputting the action control signal to an actuation system on the physical embodiment. The method may further include adjusting weights and biases of the at least some of the plurality of qubits in the quantum decision agent based on a measurement result of a previous measurement. Attempting to match the classical sensor information to a stored feature pattern may be performed by a classical AI decision agent. The classical sensor data may include information about an environment of the physical embodiment. The actuation system may affect the environment of the physical embodiment.

A system may be summarized as including: one or more classical processors and one or more storage devices storing instructions that are operable, when executed by the one or more classical processors, to cause the one or more classical processors to perform operations for controlling a physical embodiment, the operations comprising: receiving classical sensor data from the physical embodiment; in a classical decision agent, attempting to match the classical sensor data to a stored feature pattern within a threshold; if a match within the threshold is found, in the classical decision agent: looking up a learned response for the stored featured pattern; and outputting the learned response to control an actuator of the physical embodiment; if no match within the threshold is found, in a quantum decision agent: converting the classical sensor data into quantum input data for a plurality of qubits; evolving a quantum state of at least some of the plurality of qubits; and measuring the quantum state; converting the quantum state into an action control signal; and outputting the an action control signal to an actuation system on the physical embodiment.

Embodiments of the present disclosure as recited herein may be combined in any combination or permutation.

### BRIEF DESCRIPTION OF THE FIGURES

For a better understanding of the present disclosure, as well as other aspects and further features thereof, reference is made to the following description which is to be used in conjunction with the accompanying figures which illustrate embodiments or aspects of the disclosure, where:

FIG. 1 is an illustration of an example hybrid quantum-classical control system for an artificially intelligent entity, in accordance with the present disclosure;

FIG. 2 is a flowchart of an example hybrid quantum-classical control method, in accordance with the present disclosure;

FIG. 3 is a schematic representation of the cognitive architecture of a quantum decision agent implemented in a hybrid quantum-classical control system for a physical embodiment, in accordance with the present disclosure;

FIG. 4 is a schematic representation of an example of a cognitive architecture for a hybrid quantum-classical control system, in accordance with the present disclosure;

FIG. 5 is a schematic depiction of a quantum decision agent implemented as a quantum Hebbian neural network, in accordance with the present disclosure;

FIG. 6 is a schematic representation of a quantum processing unit making an action decision at a high level of motor control, in accordance with the present disclosure;

FIG. 7 is a schematic representation of a quantum processing unit making an action decision at a low level of motor control, in accordance with the present disclosure;

FIG. 8 is a block diagram of an example connection system of a hybrid quantum-classical control system to a physical embodiment hardware, in accordance with the present disclosure;

FIG. 9 is a block diagram of an example computing infrastructure setup a hybrid quantum-classical control system, in accordance with the present disclosure;

FIG. 10 is an example of the spin states of a 8-qubit quantum decision agent changing over time;

FIG. 11 is a graph of the energy of an Ising spin system decreasing over time when a Hebbian Learning algorithm is run on an annealing processor; and

FIG. 12 is a visualization of experimental data obtained from a quantum decision agent with an example of a system described in the present disclosure.

### DETAILED DESCRIPTION OF THE DISCLOSURE

Unless defined otherwise, all technical and scientific terms used herein have the same meaning as commonly understood by one of ordinary skill in the art to which this disclosure belongs. Working examples provided herein are considered to be non-limiting and merely for purposes of illustration.

As used in the specification and claims, the singular forms “a”, “an” and “the” include plural references unless the context clearly dictates otherwise.

The term “comprise” and any of its derivatives (e.g. comprises, comprising) as used in this specification is to be taken to be inclusive of features to which it refers, and is not meant to exclude the presence of any additional features unless otherwise stated or implied. The term “comprising” as used herein will also be understood to mean that the list following is non-exhaustive and may or may not include any other additional suitable items, for example one or more further feature(s), component(s) and/or element(s) as appropriate.

As used herein, the terms “having,” “including” and “containing,” and grammatical variations thereof, are inclusive or open-ended and do not exclude additional, unrecited elements and/or method steps, and that that the list following is non-exhaustive and may or may not include any other additional suitable items, for example one or more further feature(s), component(s) and/or element(s) as appropriate. A composition, device, article, system, use, process, or method described herein as comprising certain elements and/or steps may also, in certain embodiments consist essentially of those elements and/or steps, and in other embodiments consist of those elements and/or steps and additional elements and/or steps, whether or not these embodiments are specifically referred to.

As used herein, the term “about” refers to an approximately +/−10% variation from a given value. It is to be understood that such a variation is always included in any given value provided herein, whether or not it is specifically referred to. The recitation of ranges herein is intended to convey both the ranges and individual values falling within the ranges, to the same place value as the numerals used to denote the range, unless otherwise indicated herein.

The use of any examples or exemplary language, e.g. “such as”, “exemplary embodiment”, “illustrative embodiment” and “for example” is intended to illustrate or denote aspects, embodiments, variations, elements or features relating to the disclosure and not intended to limit the scope of the disclosure.

As used herein, the terms “connect” and “connected” refer to any direct or indirect physical association between elements or features of the present disclosure. Accordingly, these terms may be understood to denote elements or features that are partly or completely contained within one another, attached, coupled, disposed on, joined together, entangled with, in communication with, operatively associated with, etc., even if there are other elements or features intervening between the elements or features described as being connected.

As used in this application, the terms “component,” “system,” “platform,” “layer,” “controller,” “terminal,” “station,” “node,” “interface” are intended to refer to a computer-related entity or an entity related to, or that is part of, an operational apparatus with one or more specific functionalities, wherein such entities can be either hardware, a combination of hardware and software, software, or software in execution. For example, a component can be, but is not limited to being, a process running on a processor, a processor, a hard disk drive, multiple storage drives (of optical or magnetic storage medium) including affixed (e.g., screwed or bolted) or removably affixed solid-state storage drives; an object; an executable; a thread of execution; a computer-executable program, and/or a computer. Both an application running on a server and the server can be a component. One or more components can reside within a process and/or thread of execution, and a component can be localized on one computer and/or distributed between two or more computers. Also, components as described herein can execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). A component can be an apparatus with specific functionality provided by mechanical parts operated by electric or electronic circuitry which is operated by a software or a firmware application executed by a processor, wherein the processor can be internal or external to the apparatus and executes at least a part of the software or firmware application. A component can also be an apparatus that provides specific functionality through electronic components without mechanical parts, the electronic components can include a processor therein to execute software or firmware that provides at least in part the functionality of the electronic components. Interface(s) can include, for example, input/output (I/O) components as well as associated processor, application, or Application Programming Interface (API) components. While the foregoing examples are directed to aspects of a component, the exemplified aspects or features also apply to a system, platform, interface, layer, controller, terminal, and the like.

As used herein, the term “agent” refers to a system of software (e.g., an application or program) that uses artificial intelligence (AI) to pursue goals and complete tasks. It is common for an agent to leverage reasoning, planning, and/or memory, and/or to have a level of autonomy to make decisions, learn, and/or adapt.

As used herein, the term “entity” refers to a system under control by at least one agent. An entity may have a physical embodiment having at least one sensor for sensing an environment around itself and capable of reaction based on input to the sensor. The entity can be, for example, a physical robot, virtual robot, avatar, non-playable character in a virtual world (e.g., in a video game), sensorimotor construct, or autonomous mechanical construct, which in any case can be controlled by the present control system. In general, an entity that is controlled by an agent is referred to here as an “artificially intelligent entity”. In some implementations, the entity can be or include a user interface on a device, where the device comprises, for example, a keyboard-mouse-screen interface, a touchscreen interface such as a cellphone or tablet interface, or hand and head trackers on a VR headset. In a user interface embodiment, the sensor data could be obtained from pixels on the screen and the actuation output of the agent could be any type of data output, including but not limited to click locations and type, keyboard keystrokes, or audio sent into the device microphone.

Herein is described a hybrid quantum-classical control system for an artificially intelligent entity. The present system addresses the challenges of understanding and decision-making in artificially intelligent entities (including but not limited to physical embodiments) in situations outside of those seen in classical artificial intelligence (AI) training data. Specifically, by integrating quantum computing principles into AI (e.g., and robotics where applicable) to simulate decision-making processes, a quantum decision agent can assist the artificially intelligent entity (e.g., physical or virtual embodiment) with decision-making when there is no reasonable precedent in a pattern library to instruct the artificially intelligent entity (e.g., physical or virtual embodiment) on how to proceed. In this way, decision-making and learning in edge-cases that are outside of training data or prior experience of a classical AI system can be assisted or augmented by a quantum decision agent, and in any step of a process where there is insufficient training data from a classical AI decision agent. Without being bound by theory, the present system and method can enable decision-making in artificially intelligent systems in a way that requires less training data than classical approaches.

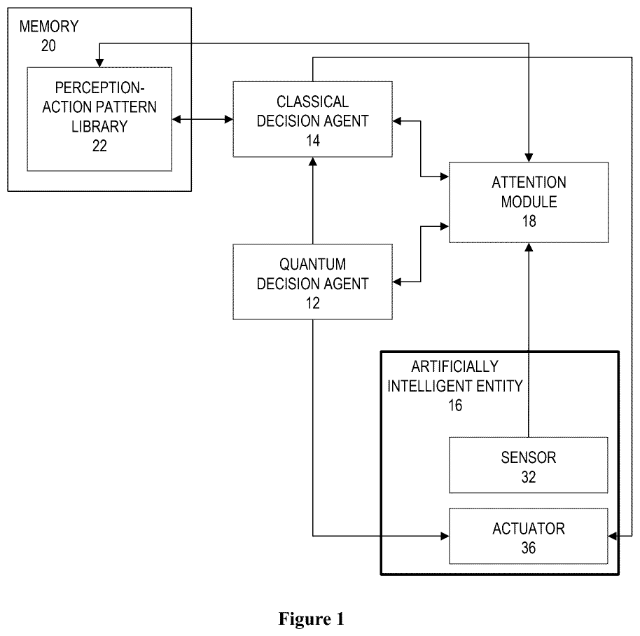

FIG. 1 is an illustration of an example hybrid quantum-classical control system for an artificially intelligent entity (e.g., physical or virtual embodiment) 16. The control system comprises a quantum decision agent 12 and classical decision agent 14 which together inform an attention module 18 to direct the action of the artificially intelligent entity (e.g., physical or virtual embodiment) 16. Sensor 32 on the artificially intelligent entity (e.g., physical or virtual embodiment) 16 receives sensor input about the environment of the artificially intelligent entity (e.g., physical or virtual embodiment) 16 and provides that sensor input to the attention module 18, which can utilize the quantum decision agent 12 and classical decision agent 14 to direct a suitable action to the artificially intelligent entity (e.g., physical or virtual embodiment) 16. In some instances, the action may be performed by, or involving, at least one actuator 36 component of artificially intelligent entity 16.

The classical decision agent 14, which can comprise a classical AI decision agent, is connected to one or more memory 20, which comprises a perception pattern library 22, an action pattern library 24, and a sensorimotor pattern library 26. The classical decision agent may be implemented in a single system such as an artificial neural network, where in some embodiments the classical decision agent can update the artificial neural net model weights, and the classical decision agent can use the artificial neural net model weights for inference. The classical decision agent 14 can comprise a classical artificial intelligence (AI) that can be run in learning mode, where training data is supplied to train the agent, and/or in inference mode. The perception-action pattern library 22 can, in some embodiments, be equivalent to the model weights of a neural network. In an example, the classical decision agent 14 can run in inference mode, whereby it uses an existing perception-action library to arrive at a suitable action command, optionally using a trained neural network. In another example, the classical decision agent can run in training mode, whereby it can update the perception-action library. Information from the quantum decision agent 12 can be used to supply training data to the perception-action pattern library used by the classical decision agent.

In one example, the quantum decision agent 12 can be run on a gate model quantum processor, wherein the connections between the plurality of input qubits and the plurality of output qubits comprise a set of parameterized quantum gates together forming a quantum circuit. In another example, the connections between the plurality of input qubits and the plurality of output qubits in the quantum decision agent 12 can comprise a set of couplings between spin states on a quantum annealing based processor.

In practice, in a decision-making requirement from the artificially intelligent entity (e.g., physical or virtual embodiment) 16, a query from the attention module 18 through the classical decision agent 14 can engage memory 20 to determine if a perception pattern is recognizable at a certain threshold, and if so, if the recognized perception pattern has a related action pattern. A similar query can call on the sensorimotor pattern library 26 to determine if a particular sensorimotor pattern exists that is relevant to the sensor input from sensor 32. If there is no pattern match of perception pattern or sensorimotor pattern, the attention module 18 can call upon the quantum decision agent 12 to assist with decision making based on the sensor data from the sensor 32 on the artificially intelligent entity (e.g., physical embodiment or virtual embodiment) 16. The attention module 18 can thereby receive and process information from the artificially intelligent entity (e.g., physical or virtual embodiment) and select which subset of information to route to either the quantum decision agent or the classical decision agent. To decide whether the information should be sent to the quantum decision agent 12 or the classical decision agent 14, the attention module 18 can query the perception-action pattern library 22 to see if there is an existing pattern that matches to within a desired threshold.

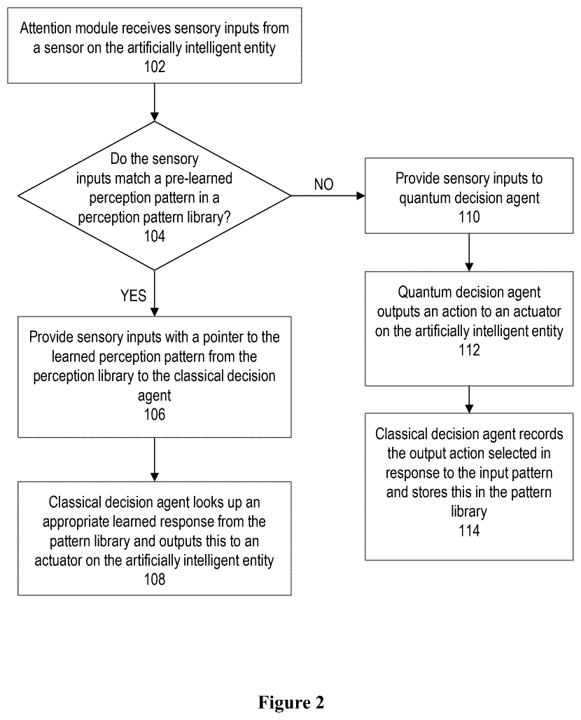

FIG. 2 is a flowchart of an example hybrid quantum-classical control method. In a first step the attention module receives sensory inputs from a sensor on the artificially intelligent entity (e.g., physical or virtual embodiment) 102. The attention module then queries if the sensory inputs match a pre-learned perception pattern in a perception pattern library 104. If not, then the sensory inputs are provided to a quantum decision agent for decision-making 110. If yes, then sensory inputs are provided with a pointer to the learned perception pattern from the perception library to the classical decision agent 106. The classical decision making module then looks up an appropriate learned response from the pattern library and outputs this to an actuator on the artificially intelligent entity (e.g., physical or virtual embodiment) 108.

If, however, the pre-learned perception does not match to a known sensorimotor response 106, then the sensory inputs are provided to the quantum decision agent 110. The quantum decision agent then outputs an action to an actuator on the artificially intelligent entity (e.g., physical or virtual embodiment) 112, and the classical learning module records the output action selected in response to the input pattern and stores this in the pattern library 114.

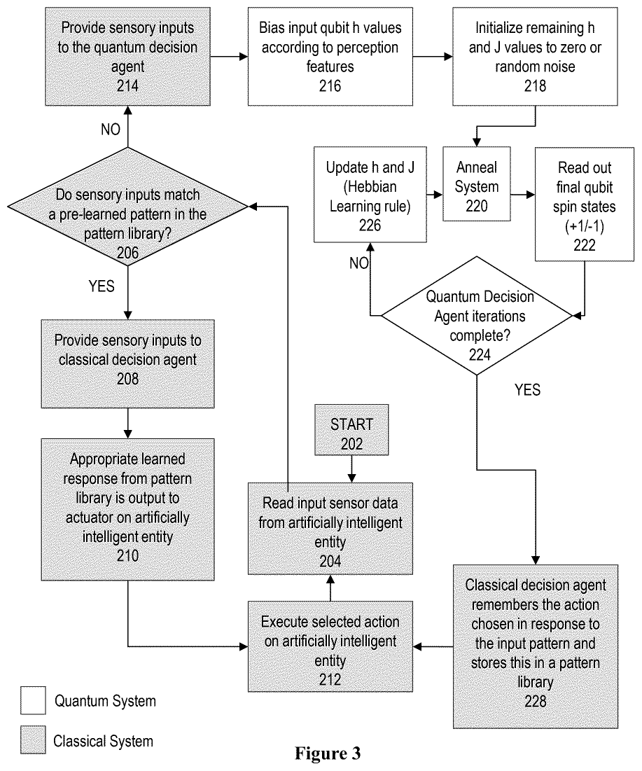

FIG. 3 is a schematic representation of the cognitive architecture of a quantum decision agent implemented in a hybrid quantum-classical control system for an artificially intelligent entity (e.g., a physical or virtual embodiment). A quantum decision agent, which optionally contains a Hebbian learning agent, can be implemented algorithmically on a quantum processing unit. A Hebbian learning agent is an artificial intelligence model inspired by the principle of Hebbian learning, which posits that the synapses between biological neurons strengthen when they are activated simultaneously. A similar methodology can be applied in quantum learning. In particular, a quantum Hebbian learning agent can be capable of adapting its connections and behaviors based on the correlations observed in input data, allowing it to learn patterns and enhance its performance over time through associative mechanisms. In the quantum decision agent, a combination of input qubits and output qubits, which have varying influence and varying strengths of connection, can be used in a quantum learning methodology for a non-biological physical embodiment.

To control an artificially intelligent entity (e.g., a physical or virtual embodiment), a connected attention module which receives sensor information from the artificially intelligent entity (e.g., physical or virtual embodiment), can access either the quantum decision agent or the classical decision agent for assistance in determining an appropriate action in response to a sensor input. The classical decision agent can be implemented algorithmically on a classical processor, such as a central processing unit (CPU) or graphical processing unit (GPU). The classical decision agent can operate in learning mode to learn feature patterns, action patterns, and sensorimotor patterns, which are combinations of feature and action patterns, and store these in a perception pattern library, action pattern library, and/or sensorimotor pattern library. This classical memory system comprising a feature pattern library, action pattern library and sensorimotor pattern library can store pre-seeded and learned patterns. The classical decision agent can also together comprise a classical artificial intelligence learning loop or classical neural network.

The attention module decides whether to farm out decision making to the quantum decision agent or to the classical decision agent based on whether a feature as obtained from one or more sensors on the artificially intelligent entity (e.g., physical or virtual embodiment) matches one or more feature pattern or sensorimotor pattern in the connected libraries. The system begins at START 202. Sensory inputs from the environment of the artificially intelligent entity (e.g., physical or virtual embodiment) are fed into the attention module 204. First, the attention module determines whether the perception pattern being attended to is recognized or not, i.e. matches a pre-learned pattern, then the attention module checks whether a pre-learned pattern corresponds to a known sensorimotor response 206. If a known sensorimotor response exists, sensory inputs are provided to the classical decision agent 208, the appropriate learned response from a pattern library is output to an actuator on the artificially intelligent entity (e.g., physical or virtual embodiment) 210, and the attention module will execute the action component of the matching sensorimotor pattern on an actuator on the artificially intelligent entity (e.g., physical or virtual embodiment) 212. If a known sensorimotor response does not exist, but the feature pattern is recognized, the attention system will send the pointer to the learned feature pattern into the quantum decision agent 214. In this case, the quantum decision agent will choose an action output and send a control signal to the artificially intelligent entity (e.g., physical or virtual embodiment) to enact the action output. A copy of the feature pattern and the chosen action pattern can also be sent to the classical decision agent for it to remember and be stored in one or more of the pattern libraries or to be provided to a neural network for training. In the quantum decision agent input h values are biased according to perception features 216 and remaining h and J values are initialized to zero or random noise 218. The quantum system can then be annealed 220 and the final qubit spin states (+1/−1) can be read out 222. The system can then query whether the quantum decision agent iterations are complete 224. If the quantum decision agent iterations are complete, then the classical decision agent can be set to remember the action chosen in response to the input pattern and optionally store the chosen action and response in a pattern library 228. If the quantum decision agent iterations are not complete, then the h and J values can be updated 226 and the quantum system can be again annealed 220.

A person of skill in the art will appreciate that, in the context of an artificially intelligent entity, references to “sensors” and “actuators” and “environment” apply to real physical sensors and actuators and environments when the artificially intelligent entity has a physical embodiment (such as a robot) and apply to simulated sensors and actuators and environments (or more generally to software that, when executed, represents sensing and actuation functions and a virtual environment) when the artificially intelligent entity has a virtual embodiment (such as an avatar or non-playable character).

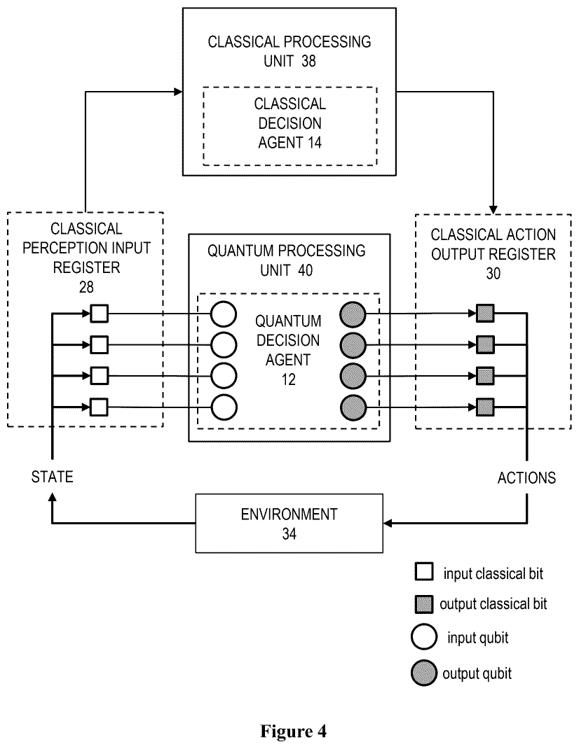

FIG. 4 is a schematic representation of an example of a cognitive architecture for a hybrid quantum-classical control system. Connections between a quantum decision agent 12 and a classical decision agent 14 are shown as an artificial learning loop in a hybrid classical-quantum control system in the environment 34 of an artificially intelligent entity (e.g., a physical or virtual embodiment). A sensor on the artificially intelligent entity (e.g., physical or virtual embodiment) receives sensor input from an environment 34 of an artificially intelligent entity (e.g., physical or virtual embodiment) which provides data on the state of the artificially intelligent entity (e.g., physical or virtual embodiment). Sensors on the artificially intelligent entity (e.g., physical or virtual embodiment) which can provide state data include but are not limited to one or more cameras, microphones, temperature sensors, balance or orientation sensors, LIDAR or SONAR sensors, depth sensors, touch sensors, motor position sensors, torque sensors, strain sensors, current or voltage sensors, proximity sensors, acceleration sensors, chemical detection sensors, pH monitors, buttons, switches, knobs, magnetic sensors, optical sensors (e.g. an optical mouse), touch screen sensors, keyboard input, or mouse click detection. This state data is sent to a classical perception input register 28 in the form of classical bits, shown as four boxes in the classical perception input register 28. In a classical learning decision-making process, these classical bits are sent to classical processing unit 38 comprising classical decision agent 14, which performs a pattern matching to existing perception (sensor), sensorimotor, and/or action patterns. This matching can be done, for example, with a neural network, classical artificial intelligence, look up table, mathematical function, or other system. If no pattern is found, the same set of classical bits can be input into a quantum decision agent 12 in a quantum processing unit 40. In the quantum processing unit 40 the input classical bits can be converted into input qubit biases, shown as open circles, which are processed in a quantum and returned as output qubits, shown as shaded circles. The output qubit values (states) can then be sent to classical action output register 30 for conversion to a classical output bit, and sent to the artificially intelligent entity (e.g., physical or virtual embodiment) to invoke an action output. An action output can be, for example, a motor output, or other types of actions, for example control of sound, lights, feedback in the form of sound notifications, text, or video, changing of power modes, controlling the position of a cursor on a screen, inputting text into an on-screen text box, etc. Other outputs can include software actions internal to the agent, for example, switching attention focus to different sub-parts of the perception input, using the classical memory system to make predictions, changing the parameters of the agent's neural net (examples include number of layers, learning rate, size of each layer) or recalling memories. Output devices that effect an action output can include but are not limited to one or more motors, piezo-electric actuators, hydraulic actuators, pneumatic actuators, light, speaker, heater, screen or other graphical user interface, vibration and buzzers, etc. Pattern encoders can run either on the hardware of a physical embodiment or on a local desktop or cloud, or may be split across two or more computing resources, depending on the processing power and bandwidth available on each device.

Once the action outputs have been updated by the quantum decision agent 12, the classical decision agent 14 can then execute an action determined based on the input state. The action is then sent to the artificially intelligent entity (e.g., physical or virtual embodiment), where it performs or otherwise implements the selected action. The selected action can also be entered as values to update the perception system based on the interaction of the artificially intelligent entity with the environment. Perception patterns returned from the environment are stored as bitstrings, and a classical pattern recognition model can observe and remember commonly occurring patterns as a classical sensorimotor pattern recognition system.

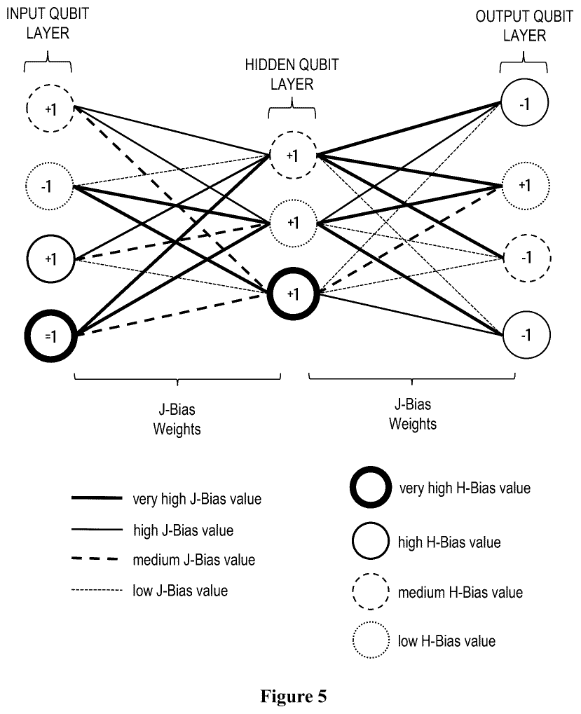

FIG. 5 is a schematic depiction of a quantum decision agent implemented, for non-limiting exemplary purposes, as a quantum Hebbian neural network with four input qubits, three hidden qubits, and four output qubits. The quantum decision agent shown has three layers: an input qubit layer; a hidden qubit layer; and an output qubit layer (as identified in FIG. 5), with eleven qubits in total. Each qubit is represented in FIG. 5 by a respective circle, and the qubit state of each qubit is shown as the number inside the circle. An input qubit is one that can be strongly biased by a classical bit of information such that it is prepared in the quantum state |0> or |1>. An output qubit is one that exists in a superposition state, but can be measured (with respect to the basis of classical information defined over the input bits), in order to produce a classical bit of information, 0 or 1.

A hidden qubit is one that is not directly connected to the outside world, and cannot be influenced by information without that information having to go through the boundary qubits, hence the term “hidden”. Hidden qubits are analogous to hidden layers in a neural network. There can be zero, one or more hidden layers. Pairs of qubits are connected by variable coupling terms, also referred to as weights-represented by straight lines connecting in between pairs of qubits in FIG. 5. Similar to a classical neural net, weights denote how strongly the bits are connected to each other, and how much their state influences the states of their neighbors. The weight of the connection between qubits are referred to as J-values in the algorithmic description, where some qubits are connected with very high J-Bias weights, and others with lower J-Bias weights, as shown. Each of the input, output, and hidden bits also have an associated H-Bias terms or strength, referred to as H-values in the algorithmic description. A high H-bias term, or qubit strength, favors a qubit towards ending up in one state versus another.

Information sent into the quantum neural network, also referred to as an annealing quantum processing unit, can be put into a highly quantum mechanical state, with the qubits demonstrating superposition and entanglement. In this artificially intelligent quantum neural network, the input qubits are populated, and the system is allowed to entangle in superposition such that the input qubits, hidden qubits, and output qubits are entangled. In an annealing process the quantum neural network reaches a decision-making point, whereupon the system performs a measurement over the action output qubits, collapsing the wave function and selecting an action. The product of the annealing process is dependent on both the J-Bias weights and H-Bias strengths of the quantum neural network, which provides the Hebbian learning component of the quantum decision agent.

For annealing, in an annealing processor, the system starts in what is called the x-basis in quantum mechanics. In this basis, all qubits are put into a superposition of 0 and 1. The basis is then slowly changed to what is known as the measurement (or z) basis, at which point the qubits will all end up in a classical state of 0 or 1. The system will stay in a low energy state during this annealing process. Quantum annealing processors are purported to be able to find lower energy states than their classically simulated counterparts due to the presence of superposition and entanglement, which allows the system to “quantum mechanically tunnel” out of an energy local minimum into a lower energy configuration. The energy state that the quantum neural network ends up in may not be the lowest energy state due to factors such as thermal and other sources of noise or bias, but that the final state chosen may be the one that attempts to minimize the energy of the quantum neural network. This action selection uses the built-in ability of physics to minimize the energy of a system, in lieu of having to encode a reward function anywhere in the system.

The quantum learning algorithm embodied by the quantum decision agent may, as a non-limiting example, provide a Hebbian learning process. This Hebbian learning process may happen within the quantum decision agent at a certain rate t_{ψ} that is native to the agent. In the Hebbian learning process, first the input bits are sampled from the input perception register and encoded into h biases on the input qubits. For example, if the bit 1 was presented to Input 1, this could be stored in the input 1 bias register as a h-value of −1. The H-biases of all other qubits, i.e. the hidden qubits and output qubits are set to random values or zero. The J-values of all qubit-qubit weights are also set to random values or zero. Then the quantum annealing process is run on the system. At the end of the anneal, all qubits, i.e. the input qubits, hidden qubits, and output qubits, collapse into states +1 or −1. To update the quantum decision agent as a Hebbian learning agent, the weights or J-Bias values that connect the qubits to each other and the H-bias values that favor each qubit towards one classical state can then be updated according to a Hebbian Learning rule based on the spin states that the qubits ended up in. For example, if q1=+1 and q2=+1, the J value between these two qubits could be modified slightly to favor alignment, and the h value of both q1 and q2 would be modified slightly towards favoring a +1 state on the next anneal. The modification amounts are weighted by adjustable J and H learning rate parameters and an optional decay rate parameter. To train the quantum decision agent successive quantum annealing processes can be run for a number of user-defined iterations N using the same input perception values. The final values of output qubits after are N iterations encoded into the output action register.

An optional reward function can also be used to augment the quantum learning algorithm or, when applicable, Hebbian learning loop as described. In the algorithm described above, which can be considered as a reward-free case, the reward function of the system is captured in the energy dynamics of the quantum processor, i.e. the system naturally selects an action by self-minimization towards an attractor state, discovering H and J parameters along the way. In this way, Hebbian learning on a processor that implements quantum mechanics to select an action can be viewed as similar to how life may use quantum mechanics to select action. In this case life does not need a built in reward function. Other ways may also be used to implement a reward function in the system. In one example, the reward-function-free Hebbian learning agent could be replaced by an optional externally programmed reward function, where the system finds the lowest energy of a pre-specified reward function mapped into H and J parameters. This can be referred to as energy programming in an adiabatic quantum computing/quantum annealing paradigm, where the best action selection corresponds to the lowest energy state of the qubits according to the H and J values that are set by the machine learning system. Another method to implement a reward function is to modify the Hebbian Learning to include a component provided by an external reward function.. This can be viewed as similar to reinforcement learning approaches. In this case the quantum decision agent could still perform the quantum learning algorithm as described, with the exception that the H and J weights could be updated proportional to the reward that was obtained on the next timestep. In this case for example, at t=0, a particular state is read in, and an action is chosen. Then at t=1, the reward for taking that action comes back into the system and then the weights are updated according to what the reward was. This causes the system to “learn” a set of H and J weights that includes contributions both from the reward-free configuration and the external reward function.

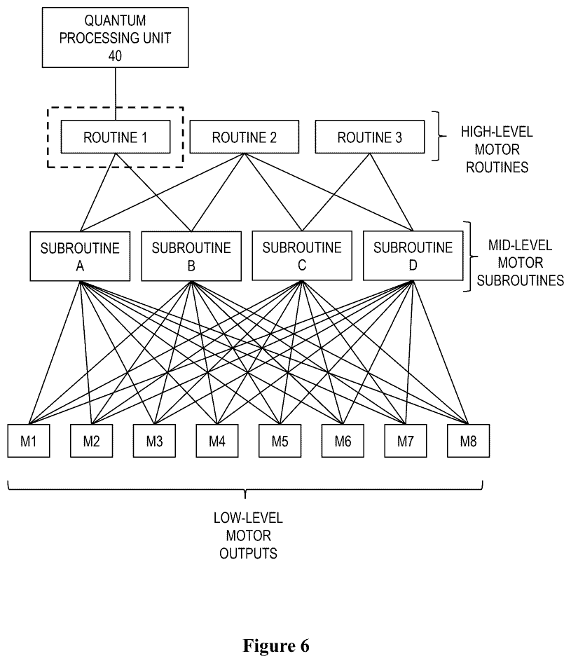

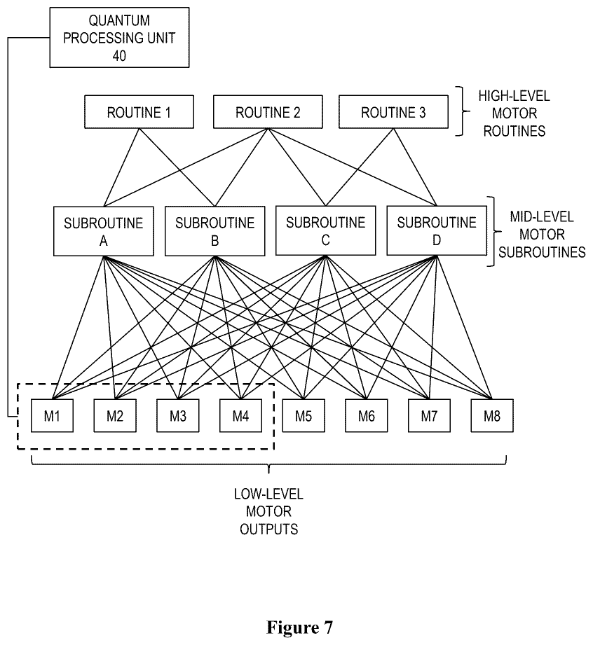

FIG. 6 is a schematic representation of a quantum processing unit making an action decision at a high level of motor control. As the quantum learning algorithm is developed further, the decision making process may be more complex and span both the classical decision agent and the quantum decision agent. For example, there may be a hierarchy of actions that are “unrolled” into individual motor updates through several levels. High-level motor control routines are represented in FIG. 6 (and in FIG. 7) as boxes labelled “Routine #”, mid-level motor control subroutines are represented in FIG. 6 (and in FIG. 7) as boxes labelled “Subroutine #”, and low-level motor outputs are represented in FIG. 6 (and in FIG. 7) as boxes labelled “M #”. The quantum decision agent may be able to make decisions to invoke actions at any level of the hierarchy. In the example in FIG. 6, the quantum processing unit 40 comprising the quantum decision agent intervenes to problem solve via a high-level action at Routine 1, and then the details of this action are unrolled through the hierarchy into low-level motor commands by the classical processor. In an example, if a robot is asked to obtain all of the red balls in a multi-colored set of balls and move them to a bin, a variety of sensor data acquisitions and responsive actions are required by the robot to perform the task. In this example, a robot may already have a routine for identifying a ball (i.e. from a group of objects that are not balls), identify the color “red”, and move an object to a bin, but may not have a routine for grasping a ball in particular. A high level motor routine for grasping a ball may be significantly different from a similar high level motor routine for grasping a book or a plush toy, and the quantum processing unit can be used at a high level routine layer to assist the robot in selecting an appropriate action for grasping a ball.

FIG. 7 is a schematic representation of a quantum processing unit making an action decision at a low level of motor control. In the example in FIG. 7, the quantum processing unit 40 takes control of problem solving and making a decision at a low level motor command directly involving motor control outputs M1, M2, M3, and M4. In the ball selection example above, the robot may already have a routine for grasping a ball, but the routine may be patterned after one for small steel ball bearings and the task at hand may involve larger plastic whiffle balls. When the system is in a state that does not “match” any of the corresponding routines, the quantum processing algorithm can “drop down” to a lower level of control. So if the required action of “grasp ball” does not yield a pattern matched set of sensory predictions along the way, the quantum learning algorithm can drop down to decision making at a lower level, such as at a motor control level. In this example, the motor speed, grasping digit configuration, and grasping strength can be adjusted to enable the robot or physical embodiment (or virtual embodiment) to change its action pattern to accommodate a larger, lighter, more fragile ball than one it has previously grasped.

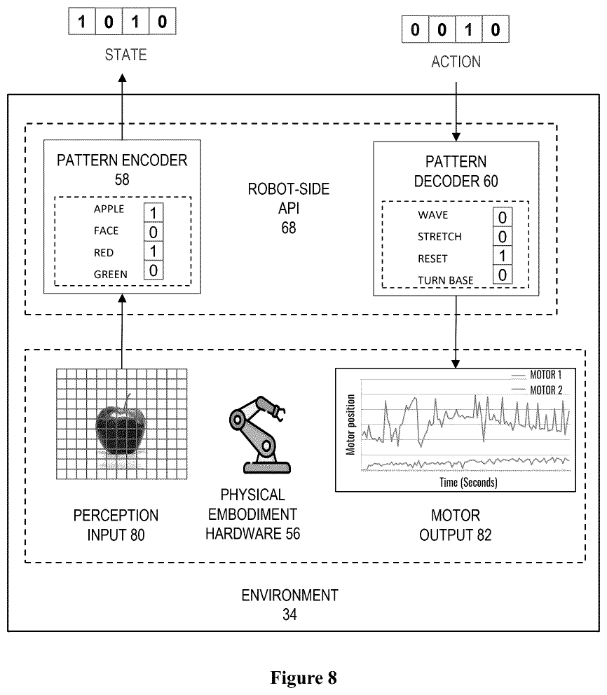

FIG. 8 is a block diagram of an example connection system of a hybrid quantum-classical control system to an artificially intelligent entity (i.e., physical embodiment hardware in the illustrative example of FIG. 8). This example system setup illustrates one configuration showing which parts of the system run on which physical computing resources and where these resources are located. The physical embodiment or robot in environment 34 is shown with a physical embodiment hardware 56 and robot-side application programming interface (API) 68. The physical embodiment hardware 56 has a sensor or perception input 80 to receive an environment state, and a motor output 82 to effect an action. Robot-side API 68 has a pattern encoder 58 to encode the state received from the perception input 80, and a pattern decoder 60 to receive the coded result action of the control system having the classical decision agent and quantum decision agent and converting it to a control signal to effect and action at the motor output 82. Although this example has a motor as an example action effector, it is understood that the action may be done on any output device as described herein. Pattern encoders may also be run either on the robot or physical embodiment hardware or on the local desktop or external connected processor, or may be split across two or more resources, depending on the processing power and bandwidth available on each device and system design.

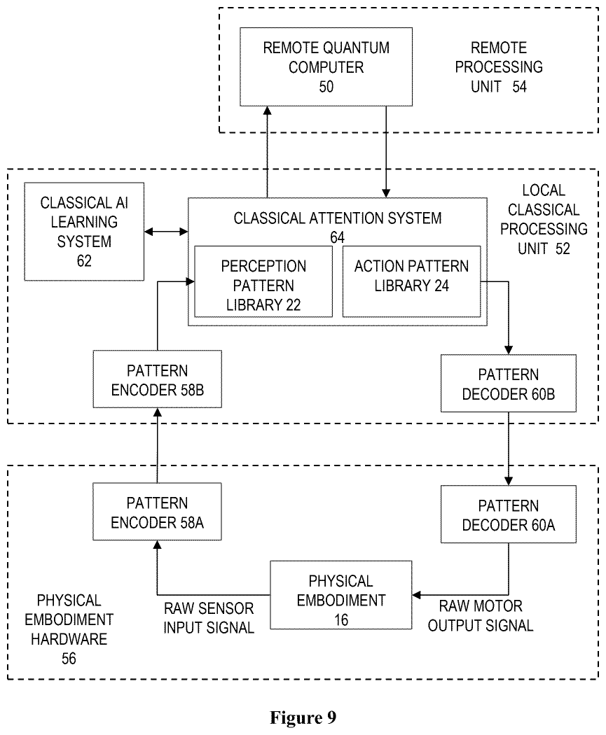

FIG. 9 is a block diagram of an example computing infrastructure setup for a hybrid quantum-classical control system. In this illustrative example configuration of components, physical embodiment 16 on a physical embodiment hardware 56, having a sensor as the input device and a motor as the output device, sends a raw sensor input to pattern encoder 58A. This signal is then sent to pattern encoder 58B on a local classical processing unit 52 where it is input into a classical attention system 64. The classical attention system 64 is connected to a perception pattern library 22 and an action pattern library 24, where the input signal can be matched, if possible, to an existing perception pattern such that a suitable action pattern can be selected. A classical AI learning system 62 may also be used to find a suitable match. If no suitably matched perception pattern exists in the perception pattern library a remote processing unit 54 having a remote quantum computer 50 may be accessed to process the input signal on a quantum decision agent. It is understood that in future quantum processing units may also be local on the classical processing unit 52 and/or the physical embodiment hardware 56. Once an action is selected based on the sensor input, pattern decoder 60B on the local classical processing unit 52 can provide an action signal to pattern decoder 60A on the physical embodiment hardware 56 to effect a raw motor output signal to drive action on the physical embodiment hardware.

It is understood that a broad range of variations to the present system may be used, such as varying condition, structure, design, hardware, and method. In some embodiments, the number of input, output and hidden qubits can be varied, and the structure of the network itself (including the number of hidden layers) can be varied. The rate of measurement of the system (annealing rate), and the form of the annealing function can be varied. The classical AI subroutines can be either learned or pre-programmed subroutines, or optionally nested in a hierarchy of pointers to one another, allowing the quantum decision making to occur at multiple different levels of abstraction. The form of the physical robot or physical embodiment can vary and can have a small or large number of degrees of freedom, with many different types of sensor or input devices and many types of action effector devices. In the quantum system the way in which the qubits are implemented can differ, for example replacing the standard discrete qubit (where the output is either 0 or 1) with a continuous-value qubit where the output can be a real number, as used in continuous variable quantum computers.

In some embodiments a smaller part of the perception pattern input can be sub-selected for input into the quantum decision agent. Choosing the parameters for this sub-selection process can themselves be an action choice of the system, which can be selected by the quantum decision agent or by the classical decision agent. A Hebbian Learning algorithm may also be replaced with an equivalent gate model, also referred to as a circuit model, quantum computing learning algorithm, where instead of adjusting the weights and biases of an annealing-based quantum neural network, the results from one iteration of the quantum circuit are used to modify the parameters of the quantum circuit on the next iteration. Other variations are also conceivable.

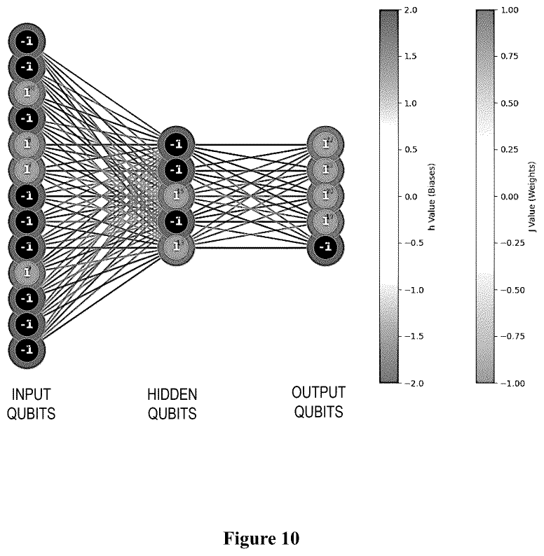

FIG. 10 is an illustrative example of a visualization of a 23-qubit quantum decision agent after an exemplary Hebbian Learning run on a simulation of the D-Wave quantum annealing hardware, showing 13 input qubits, 5 hidden qubits, and 5 output qubits, together with the final H values, J values and spin states. This experimental system was established during a 500-iteration Hebbian Learning run on a simulation of the D-Wave quantum annealing processor.

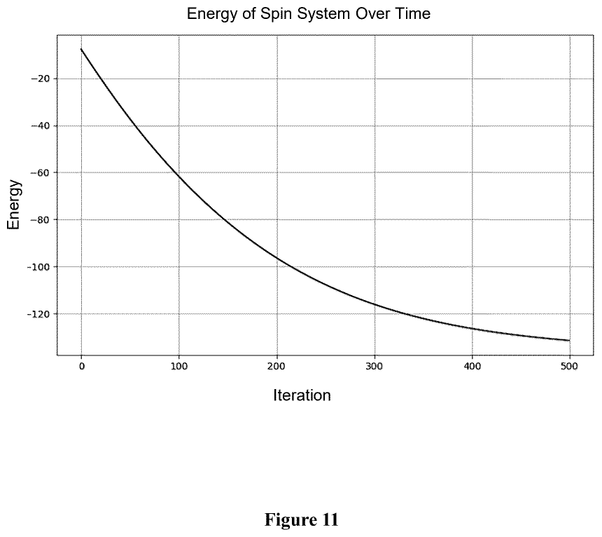

FIG. 11 is an illustrative example of a graph of the energy of an Ising quantum processing unit spin system over time when a Hebbian Learning algorithm with 500 iterations is run on an annealing processor.

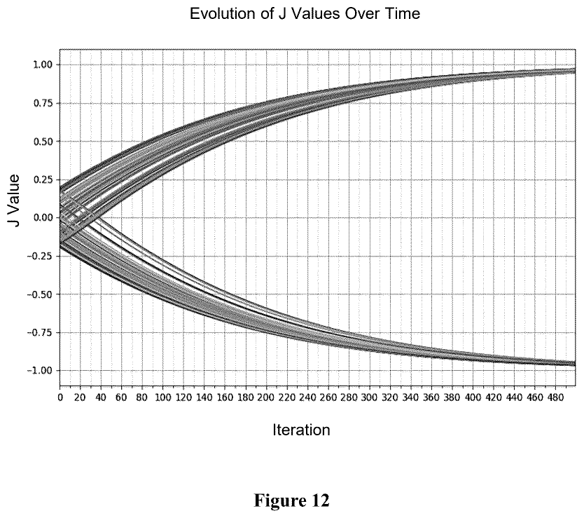

FIG. 12 is an illustrative example of a visualization of experimental data obtained from a quantum decision agent with the present system. This example illustrates the J values, or quantum neural network weights, of a quantum decision agent converging during a 500-iteration Hebbian Learning run on a simulation of the D-Wave quantum annealing processor.

As described previously, in some implementations, the action output by the quantum processing system may be used to update/train the classical neural network and improve its performance in future scenarios where similar perception input(s) is/are encountered. For example, the update applied to the classical neural network may increase the likelihood that the classical neural network will return the action output by the quantum system in future scenarios where similar perception inputs are encountered. In some implementations, the update process may include using a backpropagation style update to the weights in the various layers of the classical neural network by calculating the error between the quantum action output and the classically output action and using this to create error gradients that are propagated through the weights in the classical network.

The various implementations described herein improve the functioning of computer systems for the specific practical application of (autonomous) control of artificially intelligent entities. The present disclosure invokes a quantum processing system running a quantum learning neural network to enhance and even train an otherwise classical predictive control process, which can achieve better overall autonomous performance in the artificially intelligent entity, or at least comparable performance more efficiently by requiring less training data and/or fewer training cycles. While attempting to run an autonomous control system exclusively using quantum networks would be costly and unwieldy, the present disclosure describes an innovative hybrid control architecture that isolates situations (e.g., when a suitable pattern match is not retrievable) where quantum neural networks can be utilized to their greatest advantage and leverages their ability to outperform classical neural networks in such isolated situations. The specialized architecture is specifically well-suited to perform the methods shown in FIG. 2 and FIG. 3 and, in some implementations, may even include dedicated structures or modules, such as attention module 18, that are specifically employed in the execution of such methods. Indeed, the methods shown in FIG. 2 and FIG. 3 cannot be executed by conventional generic classical computing systems or by quantum processing systems on their own-they require the specialized integrated architectures described herein, such as hybrid quantum-classical control system shown in FIG. 1.

All publications, patents and patent applications mentioned in this specification are indicative of the level of skill of those skilled in the art to which this disclosure pertains and are herein incorporated by reference. The reference to any prior art in this specification is not, and should not be taken as, an acknowledgement or any form of suggestion that such prior art forms part of the common general knowledge.

The disclosure being thus described, it will be obvious that the same may be varied in many ways. Such variations are not to be regarded as a departure from the scope of the disclosure, and all such modifications as would be obvious to one skilled in the art are intended to be included within the scope of the following claims.

1. A hybrid quantum-classical control system comprising:
a quantum decision agent comprising a plurality of qubits;
a classical decision agent connected to a perception-action pattern library;
an attention module connected to both the quantum decision agent and the classical decision agent; and
a physical embodiment comprising:
at least one sensor that sends sensor data to the attention module; and
at least one actuator that receives a decision command from the quantum decision agent or the classical decision agent.

2. The system of claim 1 wherein the quantum decision agent supplies training data to the perception-action pattern library for use by the classical decision agent.

3. The system of claim 1 wherein the perception-action pattern library comprises sensorimotor patterns of the physical embodiment.

4. The system of claim 1 wherein the attention module receives and processes information from the physical embodiment and selects whether to route information to the quantum decision agent or to the classical decision agent.

5. The system of claim 1 wherein the at least one sensor comprises at least one sensor selected from a group consisting of: a camera, a microphone, a temperature sensor, a balance sensor, an orientation sensor, a LIDAR sensor, a SONAR sensor, a depth sensor, a touch sensor, a motor position sensor, a torque sensor, a strain sensor, a current sensor, a voltage sensor, a proximity sensor, an acceleration sensor, a chemical detection sensor, a pH monitor, a button, a switch, a knob, a magnetic sensor, an optical sensor, an optical mouse, a haptic sensor, a touch screen sensor, a keyboard input, and a mouse click detector.

6. The system of claim 1 wherein the physical embodiment is selected from a group consisting of: a physical robot, a virtual robot, an avatar, a game character, a sensorimotor construct, an autonomous mechanical construct, an agentic interface, a desktop computer, a laptop, a cellphone, and a tablet.

7. The system of claim 1 wherein the plurality of qubits have bias strengths and are connected by weights.

8. The system of claim 1 wherein operation of the quantum decision agent is independent from operation of the classical decision agent.

9. The system of claim 1 wherein the classical decision agent comprises a classical artificial intelligence (AI) operable in either or both of learning mode and inference mode.

10. The system of claim 1 wherein the at least one actuator comprises at least one motor selected from a group consisting of: a DC motor, a servomotor, a digitally controlled servomotor, a hydraulic actuator, a pneumatic actuator, and a piezo-electric actuator.

11. The system of claim 1 wherein the at least one actuator comprises at least one output device selected from a group consisting of: a muscle wire, a nitinol-based actuator, a heater, a wheel, a tank tread, a light, a LED display, an OLED display, a screen, buzzer, a sound making device, and a vibrational actuator.

12. The system of claim 11 wherein the output device provides a control signal for activation of at least one software process of the physical embodiment, and wherein the at least one software process is selected from a group consisting of: a memory recall, an attention switching, a classical decision agent subroutine, a modification of an internal parameter of the quantum decision agent, and a learning rate of a neural network of the classical decision agent.

13. The system of claim 1, further comprising:
one or more classical processors and one or more storage devices storing the classical decision agent, wherein the classical decision agent comprises instructions that are operable, when executed by the one or more classical processors, to cause the one or more classical processors to perform operations of the classical decision agent.

14. The system of claim 13 wherein the one or more storage devices further store the perception-action pattern library and the attention module.

15. A method for controlling a physical embodiment comprising:
receiving classical sensor data from the physical embodiment;
in a classical decision agent, attempting to match the classical sensor data to a stored feature pattern within a threshold;
if a match within the threshold is found, in the classical decision agent:
looking up a learned response for the stored featured pattern; and
outputting the learned response to control an actuator of the physical embodiment;
if no match within the threshold is found, in a quantum decision agent:
converting the classical sensor data into quantum input data for a plurality of qubits;
evolving a quantum state of at least some of the plurality of qubits;
measuring the quantum state;
converting the quantum state into an action control signal; and
outputting the action control signal to an actuation system on the physical embodiment.

16. The method of claim 15, further comprising adjusting weights and biases of the at least some of the plurality of qubits in the quantum decision agent based on a measurement result of a previous measurement.

17. The method of claim 15 wherein attempting to match the classical sensor information to a stored feature pattern is performed by a classical AI decision agent.

18. The method of claim 15 wherein the classical sensor data comprises information about an environment of the physical embodiment.

19. The method of claim 15 wherein the action control signal supplies training data to a perception-action pattern library used by the classical decision agent.

20. A system comprising:
one or more classical processors and one or more storage devices storing instructions that are operable, when executed by the one or more classical processors, to cause the one or more classical processors to perform operations for controlling a physical embodiment, the operations comprising:
receiving classical sensor data from the physical embodiment;
in a classical decision agent, attempting to match the classical sensor data to a stored feature pattern within a threshold;
if a match within the threshold is found, in the classical decision agent:
looking up a learned response for the stored featured pattern; and
outputting the learned response to control an actuator of the physical embodiment;
if no match within the threshold is found, in a quantum decision agent:
converting the classical sensor data into quantum input data for a plurality of qubits;
evolving a quantum state of at least some of the plurality of qubits; and
measuring the quantum state;
converting the quantum state into an action control signal; and
outputting an action control signal to an actuation system on the physical embodiment.
